(19) United States
(12) Patent Application Publication
(10) Pub. No.: US 2019/0335749 A1
(43) Pub. Date: Nov. 7, 2019

(54) Adjustable Release Pesticide Tablet Formulations

(71) Applicant: Nicholas W. Robertson, ASHLAND, WI (US)

(72) Inventor: Nicholas W. Robertson, ASHLAND, WI (US)

(21) Appl. No.: 16/405,397

(22) Filed: May 7, 2019

Related U.S. Application Data
(63) Continuation of application No. 62/667,107, filed on May 4, 2018.

(51) Int. Cl. A01N 33/22; A01N 25/10

(52) U.S. Cl. CPC A01N 33/22; A01N 25/10

(57) ABSTRACT

Pesticide formulations especially suited for commercial use in tablet form where the release rate of the pesticide is adjustable based on conditions and requirements for disintegration and dispersion in water, at any temperature, of pesticidally active compounds.

### FIELD OF THE INVENTION

This invention concerns specific pesticide formulations especially suited for commercial use in tablet form. The formulations of this invention afford adjustable release time for disintegration and dispersion in water, at any temperature, of pesticidally active compounds.

### BACKGROUND

The applications of chemicals for the control of aquatic organisms directly produce effects resulting from toxic action of the chemical itself on the target organism. Indirect effects result from the death of the surrounding organisms and consequent changes in the physical, chemical and biological nature of a treated body of water.

Nuisance aquatic organisms, which are invasive, non-native or unwanted, can be a substantial economic and health burden in many areas of the world. Such organisms can present a hazard to navigation, reduce or prevent the use of recreational facilities, serve as a habitat for harmful insects, destroy fish life, retard water flow in drainage or irrigation channels and are also aesthetically unappealing.

The adjustable-release delivery system of this invention is a composition and process which delivers a biologically active agent where the agent is released at a controlled rate over a specified period and delivered to a target. The chief advantage of adjustable release of biologically active agents is that it permits a lower dose or less toxic chemical to be used over a given period of reactivity than would have to be administered in only one or several applications of the agent. The adjustable release system has a marked advantage when potent biologically active chemicals which have a normally short half-life are used, since the long acting, adjustable release formulations will gradually release the agent thereby eliminating the normally frequent applications required for short half-life chemicals.

The biologically active agent of the invention is a pesticide. Pesticides are substances that are meant to control pests, including weeds. The term pesticide includes: herbicide, insecticides (which may include insect growth regulators, termiticides, etc.) nematicide, molluscicide, piscicide, avicide, rodenticide, bactericide, insect repellent, animal repellent, antimicrobial, and fungicide.

In general, a pesticide is a chemical or biological agent that deters, incapacitates, kills, or otherwise discourages pests. Target pests can include lamprey, insects, plant pathogens, weeds, molluscs, birds, mammals, fish, nematodes (roundworms), and microbes that destroy property, cause nuisance, or spread disease, or are disease vectors. Along with these benefits, pesticides historically also have drawbacks, such as potential toxicity to humans and other species. Such drawbacks provide the inspiration for the present invention.

Although the adjustable release system described in this specification may be used for a multitude of pests using different chemical formulations, this invention focuses on sea lamprey as a first use.

The prior art method of larval sea lamprey (Petromyzon marinus) treatments requires surfactant-based lampricide bars that are placed into the water to treat streams. The lampricide bars contain 23% 3-trifluoromethyl-4-nitrophenol (TFM) as the active ingredient (A.I.) and a surfactant-based carrier blend which is designed to release the TFM over 8-12 h. However, the lampricide bars prematurely dissolve within 5 hours.

While the surfactant-based carrier delivery system has proven useful, there is significant room for improvement in three important areas: weight percent, cost, and environmental safety. Surfactant-free formulations that applicants have developed contain up to 85% TFM and demonstrate promise for adjustable controlled release preferably from 10 to 12 hours. The formulations contain up to 3 times the TFM of the current bars. Additionally, surfactants, such as those used in the current formulation, are generally toxic to aquatic organisms and they may cause long-term adverse effects. Surfactants in current formulation have 96-h LC₅₀'s≥1 mg/L for both bluegill (Lepomis macrochirus) and zebra fish (Danio rerio), and 48-h EC₅₀'s≥1 mg/L for Daphnia magna. Additionally, some of the surfactants are not readily degradable. Although the likelihood of acute toxicity resulting from TFM bar application is low, reformulation with more environmentally compatible inert ingredients is desirable. The inert ingredients in applicant's formulations and coatings are included on EPA lists that are not anticipated to adversely impact public health or the environment.

### BRIEF DESCRIPTION OF THE DRAWINGS

FIG. 1 shows a cross section of tablet formulation, which provides three points of variation for optimizing release rates and maximizing weight percent of TFM.

FIG. 2 shows deprotonation of TFM (B) using hydroxide (A) to form the TFM phenoxide ion (C) and water.

FIG. 3 shows the effect of coating thickness on TFM release rate.

FIG. 4 shows the effect of alginate concentration on TFM release rate.

FIG. 5 shows the effect of support matrix type and thickness on TFM release rate.

FIG. 6 shows the effect of hydroxide additive on TFM release rate at low temperature.

FIG. 7 shows the effect of composition and compression on TFM release rates.

FIG. 8 shows 11 liter per minute flow through assessments of different TFM formulations containing 20 g of TFM.

FIG. 9 shows the impact of added sand (to increase tablet density) on TFM release rate.

FIG. 10 shows the impact of tablet diameter on release rates.

FIG. 11 shows the impact of fiber length on TFM release rates.

FIG. 12 shows the impact of diluting the coating concentration on TFM release rates.

FIG. 13 shows thermal stability tests of the optimized formulation demonstrate heating exhibits minimal impact on TFM release rates.

FIG. 14 shows the impact of adding other types of fillers to the coating on TFM release rates.

FIG. 15 shows the effect of 2,4-D composition on release rate.

FIG. 16 shows release rates of copper from copper sulfate and copper hydroxide containing tablets demonstrating the diverse applicability of the coatings.

### SUMMARY

A tablet is provided having an adjustable release time in water, comprising, a pesticide and an adjustable time release coating consisting of alginate. The coating further consists of cellulose and fiber. The pesticide, if it is a weak base, may further be solubilized within the coating using a weak acid or if it is a weak acid, may be solubilized using a weak base. The pesticide is specific for water born pests and may be a lampricide and may be TFM in a preferred embodiment. The pesticide is steadily released in water from time 0 to a time of 1000 hours but may be adjusted to any range within 1000 hours.

A process is provided for making an adjustable time release tablet for releasing a pesticide in water, comprising, solubilizing a pesticide sufficiently for release in water by adding a weak base to the pesticide wherein the pesticide is a weak acid and adjusting the release rate by increasing or decreasing the amount of weak base or the reverse if the pesticide is a weak base. The release rate is also adjusted by coating the pesticide with a layer of alginate sufficiently for release in water and adjusting the release rate by adding more layers. Cellulose and husk may be added to the alginate to further adjust the release rate.

### DESCRIPTION

We have developed a novel tablet TFM formulation to address the identified drawbacks of surfactant based TFM bars. FIG. 1 shows the three variables we use to fine tune TFM release rates as well as maximize the weight percent of TFM in the final product. A. Altering the size of the tablet impacts the surface area to volume ratio and therefore the release rate. Furthermore, placing the tablets inside of a biodegradable diffuser bag would further reduce the surface area to volume and localize TFM release. B. The composition of the formulation contains only TFM and compounds that aid in solubilizing the TFM (e.g. monovalent or divalent metal hydroxides (NaOH, KOH, Mg(OH)2, Ca(OH)2)) without the need for surfactants. These types of compounds can be used to control the rate at which TFM dissolves, thus providing another variable that can be used to tune release rates. Notably, these compounds have low molecular weight compared to TFM, and therefore they provide much higher weight percent of TFM than the current mix of surfactants used in the TFM bars. Furthermore, the solubilization compounds we are working with are inexpensive and are classified by the EPA as inert compounds “with sufficient data to conclude that their current use will not adversely affect the environment”. Many other aquatic solubilizers are amine-based and have secondary toxicity concerns. C. The type and thickness of the coating used for the tablets provides an important means for controlling release rates. Importantly, materials used for the coating are food additives that are safe for human ingestion and are also EPA approved inert ingredients. One preferred embodiment is sodium alginate that is solidified with calcium chloride. Alginate is a natural polysaccharide composed of α-d-mannuronic acid and β-1-guluronic acid that is derived from seaweed. Alginate polymers form gels, i.e. ionic cross-links in the presence of various divalent cations, e.g. Ca2+, Mg2+, by cross-linking the carboxylate groups of the guluronate groups on the polymer backbone. The type of coating can be modified with a support matrix (cellulosic materials), which impacts the strength, thickness and porosity. Alginates, starch and its derivatives, chitosan, cyclodextrin, carboxymethylcellulose and ethylcellulose are some of the natural polymers.

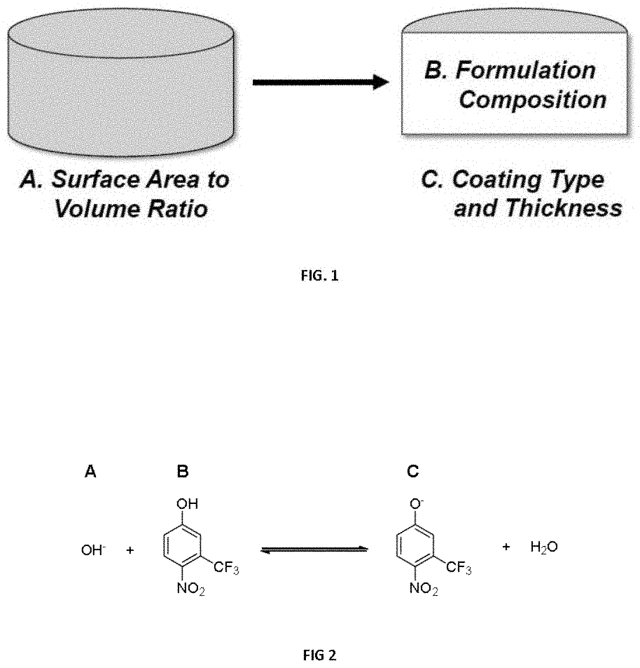

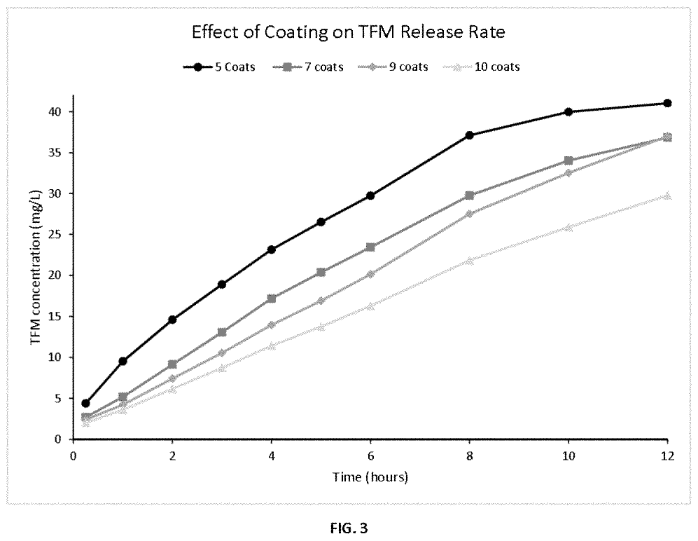

FIG. 2 shows the equilibrium between TFM and the deprotonated TFM phenoxide ion. Controlling this equilibrium is important for fine-tuning the TFM release rate from the delivery system, which can be achieved through judicious choice of the base it is paired with. Hydroxides can deprotonate the neutral TFM to form the TFM phenoxide ion, which is significantly more soluble. The source of hydroxide has an important impact on release rates. Hydroxides or alkoxides with higher solubility (e.g. NaOH, KOH, NaOMe, NaO^{t}Bu, etc.) will be present in high levels, thus leading to quick deprotonation and solublization. Hydroxides with low solubility (e.g. Mg(OH)₂, Ca(OH)₂) will be slow to dissolve and therefore slow to solubilize the TFM. Other strong or weak bases can also be used (e.g. amines, carbonates, bicarbonates, sulfates, conjugate bases of weak acids, etc.). In the absence of base, TFM release rates are significantly reduced.

### EXAMPLES

The following examples provide evidence for the importance of controlling the tablet formulation, tablet dimensions, and coating formulation.

### Example 1: Impact of Number of Alginate Coatings on TFM Release Rate

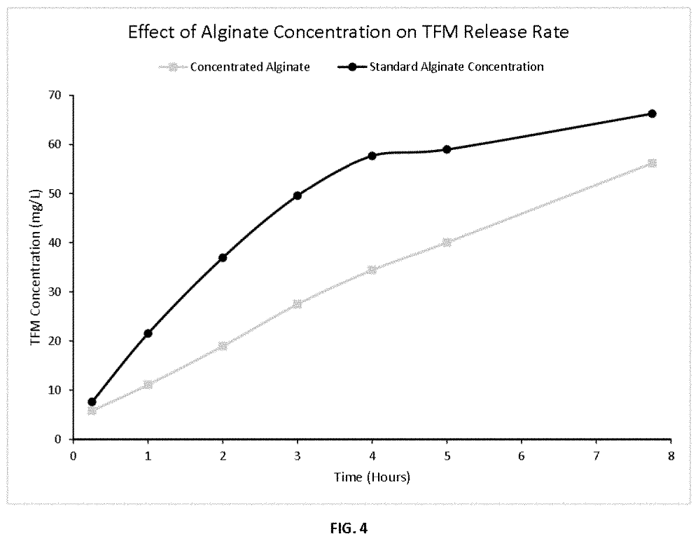

TFM and Ca(OH)₂ (0.5 g and 0.095 g, respectively) were ground into a fine powder with mortar and pestle and then pressed into 0.119 g tablets using a hammer, pin and mold. They were then coated with high G, sodium alginate (standard concentration=0.215 g in 18 mL DI H₂O), briefly immersed in Ca²⁺ chelating solution (69.1 g CaCl₂ in 2 L DI H₂O) and dried for a minimum of 15 hr under ambient conditions. Coating thickness started at five coats and increased to 10 coats. Tablets were placed individually in 2 L of DI water (stirred at 60 RPM with a 2″ magnetic stir bar), each formulation was duplicated and aliquots were taken at set time intervals. Results shown in FIG. 3 demonstrate that TFM release rates decrease with increasing numbers of coats of alginate.

### Example 2. Impact of Alginate Concentration on TFM Release Rate

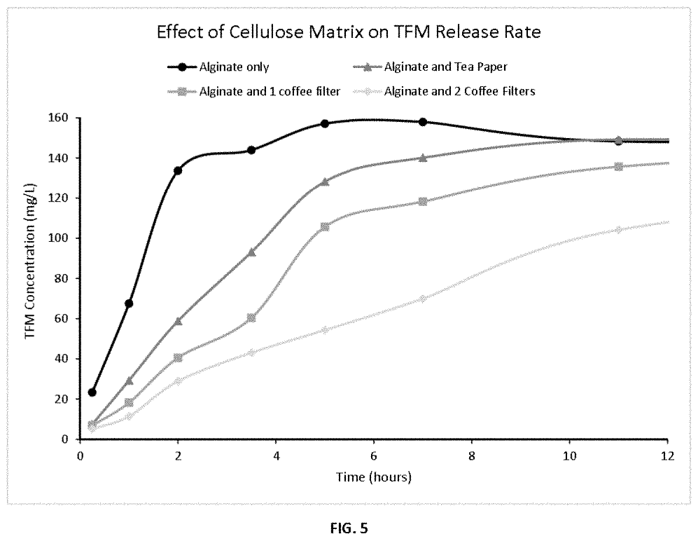

TFM Tablets were prepared and analyzed as in Example 1 above, however, the tablets were immersed one time in either standard alginate concentration (0.215 g in 18 mL DI H₂O) or concentrated alginate solution (0.496 g in 15 mL DI H₂O). Results shown in FIG. 4 demonstrate that release rate slows with a higher alginate concentration.

### Example 3. Effect of Cellulose Matrix on Tfm Release Rate

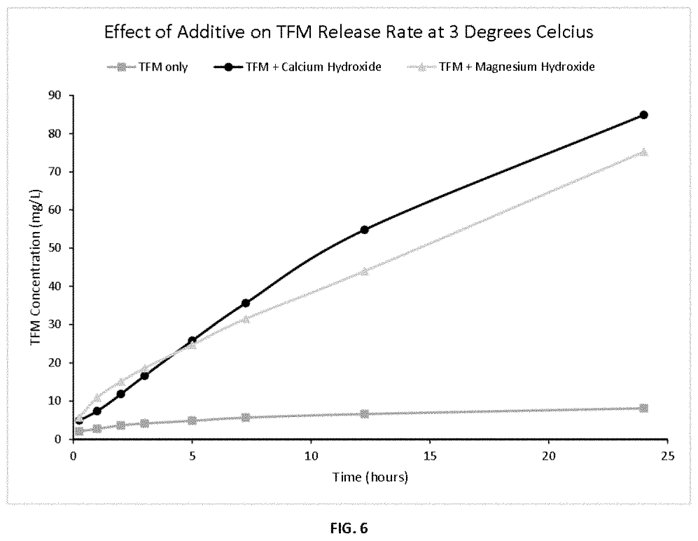

TFM (0.5 g) with a stoichiometric amount of blended Ca(OH)₂ (0.095 g) were pressed into tablets. These were wrapped with cellulose paper presoaked in standard alginate and then briefly immersed in calcium chelating solution. A blank TFM/Ca(OH)₂ tablet was prepared analogously but dipped into standard alginate, instead of wrapping with alginate soaked cellulose, and then briefly immersed in the calcium chelating solution. After drying for 24 h, the tablets were placed into 3 L of DI water and stirred at 60 RPM. Results shown in FIG. 5 demonstrate that release rate slows as pore size of the cellulose matrix decreases (coffee filter paper has smaller pore size than tea paper). Release rate also decreases with more layers of cellulose.

### Example 4. Effect of Additive on TFM Release Rate

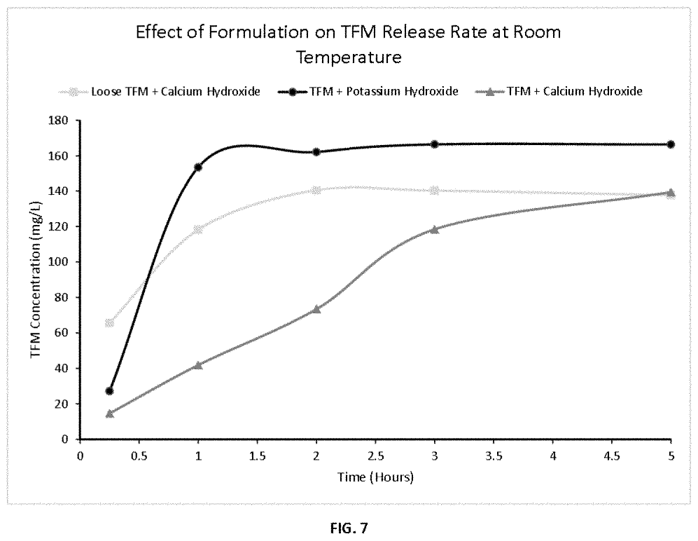

Tablets were prepared as described in Example 3 and wrapped in alginate presoaked tea paper. Magnesium hydroxide was substituted for calcium hydroxide. Tablets were placed into 3 L of DI water stirred at 60 RPM at 3° C. Plotted results in FIG. 6 demonstrate the importance of the solubilizing hydroxide as no added hydroxide leads to extremely slow release rates.

### Example 5. Effect of Additive and Compression of Formulation on TFM Release Rate

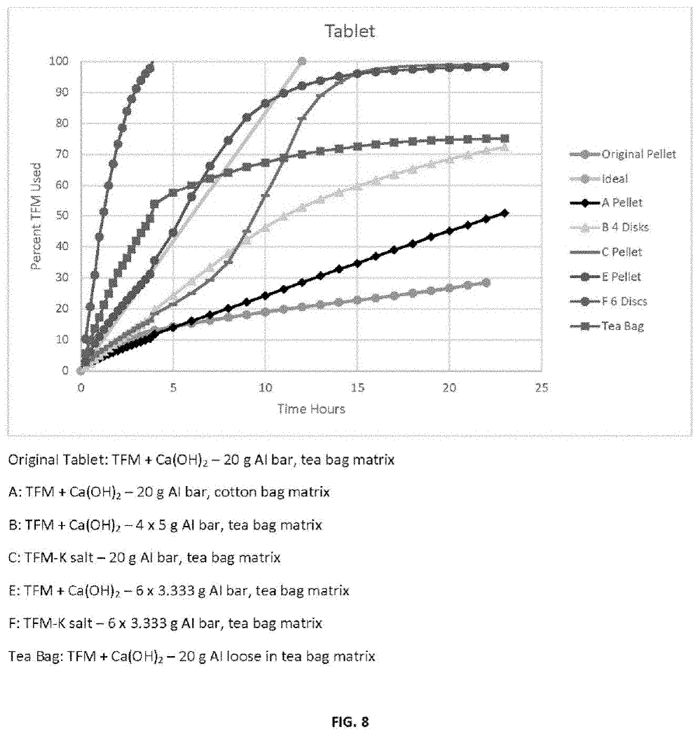

Tablets were prepared as described in Example 3 and wrapped in alginate presoaked tea paper. One formulation substituted potassium hydroxide, a highly soluble hydroxide, for calcium hydroxide. A loose formulation of TFM and Ca(OH)₂ forewent tablet pressing and was simply wrapped into tea paper. The formulations were immersed in 3 L DI water stirred at 60 RPM at room temperature. Results in FIG. 7 show that loose formulation releases faster than the compressed formulation. Furthermore, highly soluble hydroxides lead to notably faster release rates than insoluble hydroxides due to the equilibrium shown in FIG. 7.

### Example 6. Types of Coating for TFM Tablets

To scale up from the tablet press, a hand-driven compression clamp was assembled in a fashion to create a compressed 20 g TFM cylinder 1 inch in diameter or combination of tablets adding to 20 g total TFM. Variables investigated were matrix type (tea bag vs porous cotton mesh), tablet size, formulation, and compression strength of formulation. The resulting tablets were placed into a flow chamber with a flow of 11 L of water per minute and aliquots were taken at designated time periods to evaluate TFM release rates.

Six tablet types were prepared: Original tablet: this tablet is based on scale up from the formulation in Example 1, but at 20 grams of TFM and 3.58 grams Ca(OH)₂. Combined powders were ground together in a mortar and pestle and then poured into the cylindrical mold of the press. The powder was then compressed to form a TFM cylinder. These cylinders were covered in a sodium alginate infused tea bag and then immersed into Ca²⁺ chelating solution.

Tablet A: This was prepared as the original tablet, except that the tea bag was replaced with cotton mesh bearing larger pore sizes.

Tablet B: This was prepared as the original tablet, except the formulation was divided into four evenly massed tablets to increase the surface area to volume ratio.

Tablet C: Prior to forming the tablet, TFM (25 g) was mixed with a stoichiometric amount of potassium tert-butoxide (13.5 g) in tert-butanol and then evaporated to isolate the TFM phenoxide salt. The salt was then pressed into a tablet containing an equal number of mols of TFM phenoxide salt as the other experiments.

Tablet E: This was prepared as the original tablet, except that the formulation was divided evenly into 6 tablets.

Tablet F: This was prepared as Tablet C, except that the formulation was divided evenly into 6 tablets.

Tea Bag: This was prepared as the original tablet, except the formulation was not compressed, but rather added directly to an alginate soaked tea bag and immersed into calcium chelating solution.

Results in FIG. 8 demonstrate that the variables of formulation, compression strength, matrix type, and surface area to volume ratios have significant impacts on TFM release rate. The preformed TFM phenoxide salt releases the fastest due to its increased solubility. Next, the tea bag formulation demonstrates that compression of formulation slows release rates. The remaining decreasing release rates correlate with decreasing surface area to volume ratios. However, the cotton mesh with lager pore sizes releases faster than the tea bag with smaller pore sizes.

### Example 7. Impact of Increasing Concentrations of Sand on Release Rates

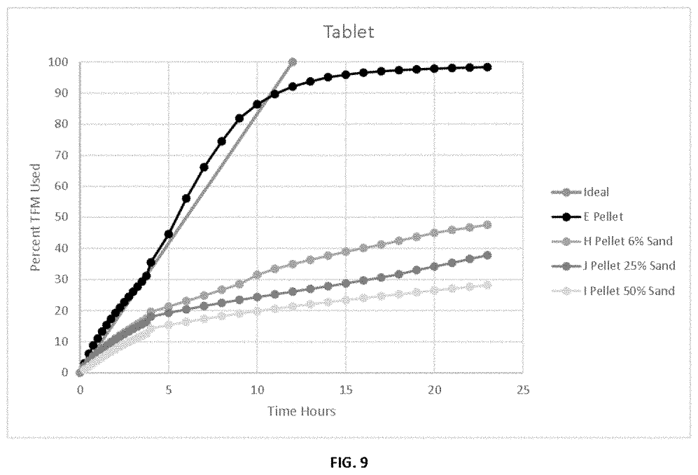

Tablets H, I and J were all prepared according to Tablet E except that increasing amounts of sand were added as a density modifier to ensure tablets remained submerged. As shown in FIG. 9, TFM release rates significantly decrease with the addition of sand.

### Example 8. Formulation Modification for Compatibility with Automated Tablet Press

Given slow rates observed in Example 7 with the addition of sand, tablet sizes needed to be reduced in order to increase surface area to volume ratios so that TFM release rates could increase to the desired 12 hour target. Smaller tablets need to be compatible with an automated tablet press in order to produce sufficient quantities in a reasonable timeframe. A compatible formulation needs to flow into the die cavity with adequate speed, compress into a tablet with enough integrity to undergo forces of ejection, and eject cleanly without caking on the die parts. Insufficient performance in any of these three areas prohibits use in a tablet press.

Formulation combinations and brief observations:
1. Original formulation scaled up (5 g TFM, 0.089 g Ca(OH)₂) resulted in caking on the press dyes and floating tablets.
2. Addition of sand (5 g TFM, 0.089 g Ca(OH)₂, and 2.96 g sand) resulted in caking on the press dyes.
3. Converting from sand to silica (5 g TFM, 0.89 g Ca(OH)₂, 2.96 g silica) resulted in caking on the press dyes.
4. Reducing silica and adding microcrystalline cellulose (5 g TFM, 0.89 g Ca(OH)₂, 1.96 g silica, 0.89 g microcrystalline cellulose (MC)) resulted in inconsistent tablets (deformities, weight differences, chips, and caking)
5. Reducing silica and adding MgSO₄ (5 g TFM, 0.89 g Ca(OH)₂, 0.98 g silica, and 0.98 g MgSO₄) resulted in swelled tablets after coating was applied.
6. Reducing silica and MC, and addition of Sodium Benzoate (5 g TFM, 0.89 g Ca(OH)₂, 0.5 g MC, 1 g MgSO₄, and 1 g Sodium Benzoate) yielded broken tablets.
7. Adding sand and MgSO₄ (5 g TFM, 0.89 g Ca(OH)₂, 1 g MgSO₄, and 1.96 g sand) resulted in solid tablets but had caking issues.
8. Addition of silica and magnesium stearate (5 g TFM, 0.89 g Ca(OH)₂, 1 g silica, and 0.89 g Mg Stearate) resulted in solid tablets and good flow in the formulation, however, caking issues developed over time and the tablets ruptured in solution.
9. Modification from silica to Ca Silicate (5 g TFM, 0.089 g Ca(OH)₂, 1.96 g Ca Silicate, and 0.89 g Mg Stearate) resulted in good tablets that pressed and coated well, however, ruptured when immersed in water.
10. Modification from Ca Silicate to silica and reduced Mg Stearate (5 g TFM, 0.89 g Ca(OH)₂, 1 g silica, and 0.445 g Mg Stearate) resulted in caking and capping of tablets.
11. Addition of sand and increased Mg Stearate (5 g TFM, 0.89 g Ca(OH)₂, 1 g sand, 0.89 g Mg Stearate) resulted in slight caking and ruptured tablets when in solution.
12. Reducing Mg Stearate, and adding sand and Ca Silicate (5 g TFM, 0.89 g Ca(OH)₂, 1 g sand, 0.445 g Mg Stearate, and 0.445 g Ca Silicate) resulted in good flow characteristics and pressed tablets, but tablets ruptured in solution.
13. Modification of sand to silica (5 g TFM, 0.89 g Ca(OH)₂, 1 g silica, 0.445 g Mg Stearate, and 0.445 g Ca Silicate) resulted in decently pressed tablets (tablets were powdery), but ruptured in solution.
14. Switching from silica to sand and removing Ca Silicate (5 g TFM, 0.89 g Ca(OH)₂, 1 g sand, and 0.445 g Mg Stearate) resulted in a clumpy formulation that lacked ability to flow.
15. Modification of increased Mg Stearate (5 g TFM, 0.89 g Ca(OH)₂, 1 g sand, 0.645 g Mg Stearate) resulted in good flowing properties as well as dense tablets, however, caking on the die occurred.
16. Modification of decreased Mg Stearate (5 g TFM, 0.89 g Ca(OH)₂, 1 g sand, and 0.125 g Mg Stearate) resulted in really good flow ability and tablet production, however, tablets ruptured in solution and exhibited floating issues.
17. Modification of sand grain size (30 vs. 40), (5 g TFM, 0.89 g Ca(OH)₂, 1 g sand, and 0.125 g Mg Stearate) resulted in no noticeable differences from #16.
18. Further decreasing Mg Stearate and increasing sand (5 g TFM, 0.89 g Ca(OH)₂, 1.5 g sand, and 0.037 g Mg Stearate) resulted in perfect flow characteristics as well as consistently dense tablets with zero caking. Tablets also showed fewer signs of floating or rupturing in solution.
19. Addition of CaCl₂ (5 g TFM, 0.89 g Ca(OH)₂, 1.5 g sand, 0.037 g Mg Stearate, and 0.075 g CaCl₂) to limit the amount of coating needed for the tablets. This resulted in a reduction of the number of coats needed, however, it increased the thickness of the coating and decreased the release rate of the TFM formulation.
20. Formulations with the TFM phenoxide salt discussed in example 6 were incompatible with the liquid coating formulations tested because the coating would not adhere.

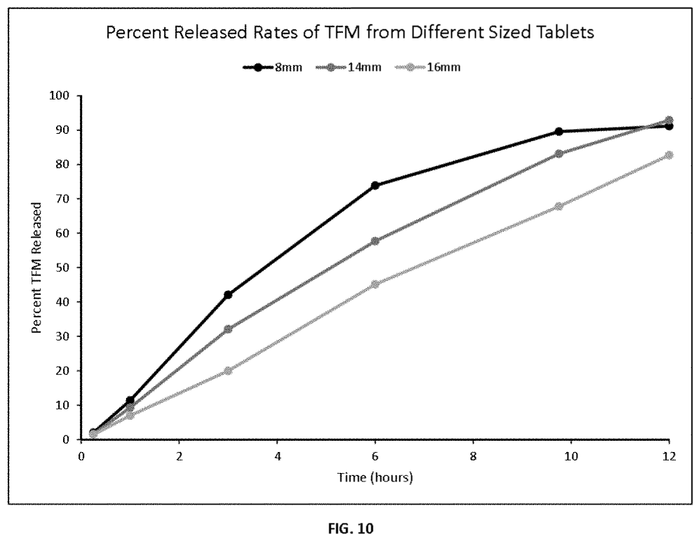

With the optimal formulation in hand (#18), tablet dimensions were investigated by changing the size of the tablet press die. FIG. 10 shows the impact of tablet dimensions on release rates.

### Example 9. Optimization of Coating Formulation

Tablets that were hand coated with tea bag paper infused with sodium alginate, then immersed into Ca²⁺ chelating solution exhibited great mechanical properties and resistance to swelling. However, this method is not scalable, especially as smaller tablet sizes are needed to increase TFM release rates. The ideal coating needs to be applied through rapid immersion in coating solutions and yield coatings that resist rupturing from osmotic pressure, while also regulating the release rate of TFM from the tablet.

Table 1 displays a variety of different combinations evaluated to meet this need. Formulations are based on the masses (in grams) of added ingredients in 40 mL of deionized water. Metamucil® contains psyllium husk and sugar, Benefiber® contains wheat dextrin, and cellulose fibers had increasing fiber lengths when going from 40 to 400. Tablets were immersed in these solutions, chelated with calcium and then evaluated for their integrity and release rate profiles.

TABLE 1
Coating Combinations

| | 0.120 g | | | | # of |
|---|---|---|---|---|---|
| Fiber | Alginate | 0.239 g Alginate | 0.356 g Alginate | 0.478 g Alginate | Coats |
| N/A | N/A | Alginate Only | N/A | Alginate Only | 1, 2, 3 |
| Metamucil ® | N/A | 0.15, 0.3, 0.6 | N/A | 0.15, 0.3, 0.6 | 1, 2, 3 |
| Benefiber ® | N/A | 0.15, 0.3, 0.6 | N/A | 0.15, 0.3, 0.6 | 1, 2, 3 |
| Organic Husk | N/A | 0.15, 0.3, 0.6 | N/A | 0.15, 0.3, 0.6 | 1, 2, 3 |
| Cellulose | 0.075, 0.15, 0.225, | 0.075, 0.15, 0.225, | 0.075, 0.15, 0.225, | 0.075, 0.15, 0.225, | 1, 2, 3 |
| Fiber: | 0.3 | 0.3 | 0.3 | 0.3 | |
| 40, 200, 300, 400 | | | | | |
| Metamucil | N/A | 0.1, 0.2 | N/A | 0.1, 0.2 | 1, 2 |
| (0.3 g) + Fiber | | | | | |

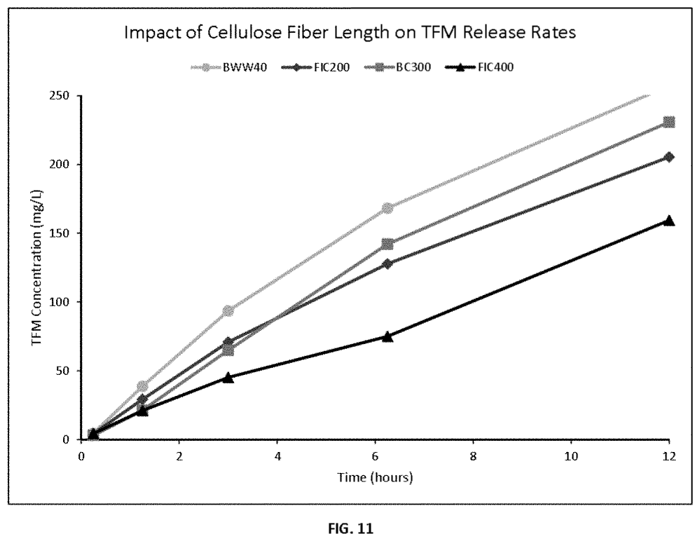

The added cellulose fibers had an important impact on improving resistance to the tablet rupturing. Longer fibers provided better integrity of the tablet, however, longer fibers also slowed release rates (FIG. 11).

The optimal coating formulation from these experiments was determined to be 0.478 g sodium alginate, 0.3 g Metamucil®, and 0.4 g cellulose fiber (300) in 40 mL of deionized water. However, release rates slowed when tablets coated with this formulation were heated. In order to improve release rates and thermal stability, glycerol or water (by volume percent) was added.

TABLE 2
Additives (by volume) to the coating to prevent cracking
during heat stressing and increase release rates

| Additives | 5% | 10% | 25% | 35% | 50% |
|---|---|---|---|---|---|
| Glycerol | No effect | Holes in | Success | Dried | Dried sticky, |
| | | dried | initially, but | tacky/ruptures | ruptures |
| | | coating | ruptures with | | |
| | | | time | | |
| H₂O | N/A | N/A | Optimal | N/A | Holes in coating, |
| | | | release kinetics | | ruptures |

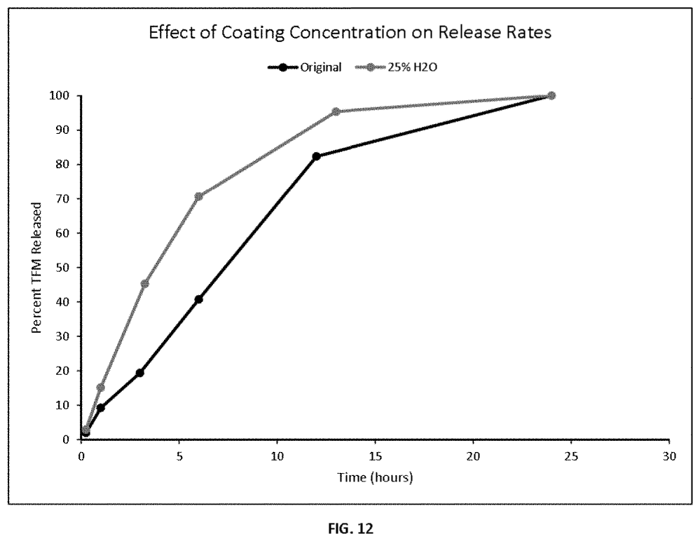

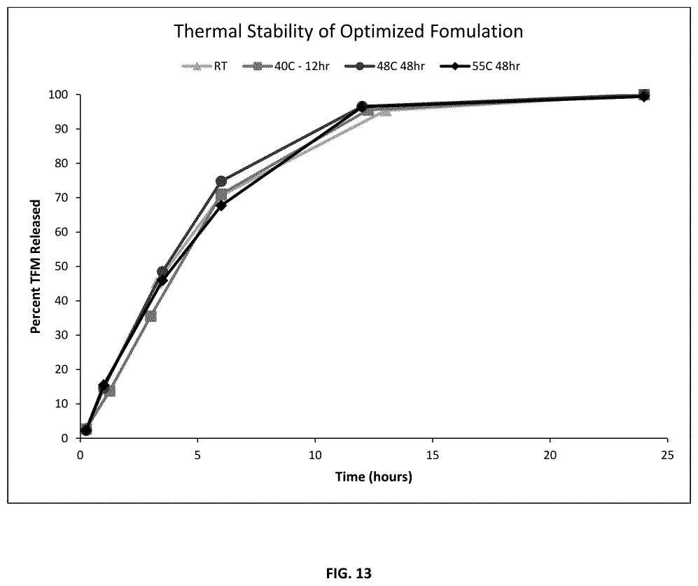

It was found that diluting the formulation by 25% with water and applying two coats led to the optimal coating formulation balance for providing targeted TFM release rates and thermal stability. FIG. 12 demonstrates the acceleration of TFM release rates and FIG. 13 shows the thermal stability of the optimized system, which is an important attribute given that the formulation will be exposed to high temperatures while stored and transported in trailers during the summer application season.

### Example 10. Addition of Inorganic Fillers to Coating

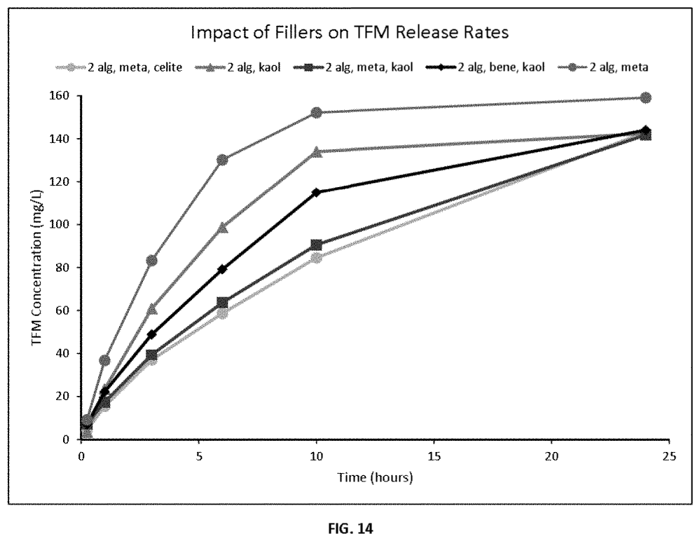

TFM tablets were coated with solutions of sodium alginate (0.478 g in 40 mL) that contained Metamucil® or Benefiber® (0.3 g), and/or kaolinite or Celite (2 g). Significant slowing of TFM release occurs with the addition of celite or kaolinite (FIG. 14).

### Example 11. Coating and release of 2,4-Dichlorophenoxyacetic Acid (2,4-D)

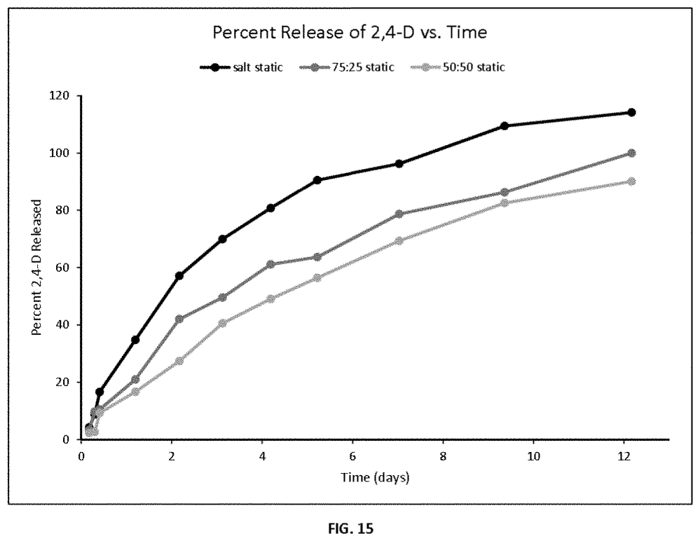

The coating that was developed in Example 9 was used in developing a 2,4-D tablet. By varying the ratio of 2,4-D acetate (more water soluble) with neutral 2,4-D (less water soluble) and a stoichiometric amount of calcium hydroxide, the release rates were tunable, demonstrating the broad applicability for this system (FIG. 15). All current granular 2,4-D formulations release their active ingredient within 24 hours.

### Example 12. Coating and Release of Copper

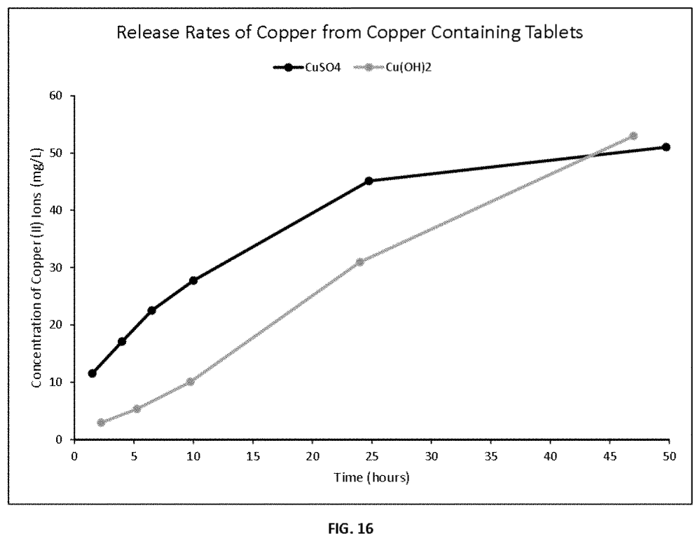

The coating that was developed in Example 9 was used in developing a copper tablet. Copper sulfate is a highly soluble salt used to control a variety of unwanted aquatic algae, plants and animals. Current formulations release active ingredient immediately. Controlled release would be desirable for some applications. FIG. 16 shows the results of coated copper sulfate release compared to coated copper hydroxide release. Copper hydroxide has extremely low solubility, but coupling it with a weak acid (such as potassium hydrogen sulfate) regulates the release rate. These results demonstrate the broad applicability of these systems and provide an example of using a weak acid to control release rates of a weak base active ingredient.

The foregoing is considered as illustrative only of the principles of the invention. Furthermore, since numerous modifications and changes will readily occur to those skilled in the art, it is not desired to limit the invention to the exact construction and operation shown and described. Therefore, suitable modifications and equivalents fall within the scope of the invention.

We claim:

1. A tablet having an adjustable release time in water, comprising: a pesticide and an adjustable time release coating consisting of alginate.

2. The tablet of claim 1 wherein the coating further consists of fiber.

3. The tablet of claim 2 wherein the coating further consists of cellulose.

4. The tablet of claim 2 wherein the pesticide is solubilized within the coating.

5. The tablet of claim 4 wherein the pesticide, if an acid, is solubilized with a base or if a base, is solubilized with an acid.

6. The tablet of claim 5 wherein the base is an hydroxide.

7. The tablet of claim 6 wherein the pesticide is a weak acid.

8. The tablet if claim 1 wherein the pesticide consists of a pesticide specific for water born pests.

9. The tablet of claim 8 wherein the pesticide consists of a lampricide.

10. The tablet of claim 9 wherein the pesticide consists of TFM.

11. The tablet of claim 1 wherein the pesticide is steadily released in water from between 0 and 20 hours.

12. The tablet of claim 11 wherein the pesticide is steadily released in water between 0 and 14 hours.

13. A process for making an adjustable time release tablet for releasing a pesticide in water, comprising: coating a pesticide with a layer of alginate sufficiently for release in water and adjusting the release rate by adding more layers.

14. The process of claim 13 wherein the release rate is adjusted by adding fiber.

15. The process of claim 14 wherein the release rate is adjusted by adding cellulose.

16. A process for making an adjustable time release tablet for releasing a pesticide in water, comprising: solubilizing a pesticide sufficiently for release in water by adding a weak base to the pesticide when the pesticide is a weak acid or by adding a weak acid to the pesticide when the pesticide is a weak base and adjusting the release rate by increasing or decreasing the amount of additive.

17. The process of claim 16 wherein the release rate is adjusted by coating a pesticide with a layer of alginate sufficiently for release in water and adjusting the release rate by adding more layers.

18. The process of claim 17 wherein the release rate is adjusted by adding fiber to the alginate.

19. The process of claim 18 wherein the release rate is adjusted by adding cellulose to the alginate.

20. The process of claim 16 wherein the pesticide is TFM.
